(19) United States
(12) Patent Application Publication
(10) Pub. No.: US 2002/0016712 A1
(43) Pub. Date: Feb. 7, 2002

(54) Feedback of recognized command confidence level

(76) Inventors: Lucas Jacobus Franciscus Geurts, Eindhoven (NL); Paul Augustinus Peter Kaufholz, Eindhoven (NL)

Correspondence Address: U.S. Philips Corporation, 580 White Plains Road, Tarrytown, NY, 10591, US

(21) Appl. No.: 09/906,605

(22) Filed: Jul. 17, 2001

(30) Foreign Application Priority Data
Jul. 20, 2000 (EP) 00202607.8

(51) Int. Cl. G10L 21/00

(52) U.S. Cl. 704/275

(57) ABSTRACT

An interactive user facility is operated through inputting voiced user commands, recognizing commands, executing recognized commands, and generating user feedback as regarding the progress of the operating. In particular, the recognizing asserts an associated confidence level and generates the user feedback through for a questionable command recognition presenting audio and/or video amending of the feedback with respect to both a correct recognition and with respect to a faulty recognition.

### BACKGROUND OF THE INVENTION

The invention relates to a method as recited in the preamble of claim 1. Voice control of interactive user facilities is being considered as an advantageous control mode in various environments, such as for handicapped persons, for machine operators using their hands for other tasks, as well as for the general public who find such feature an extremely advantageous convenience. However, speech recognition is not yet perfect. Recognition errors come in various categories: deletion errors will fail to recognize a speech item, insertion errors will recognize an item that has not effectively been uttered, and substitution errors will recognize another item than the one that has effectively been uttered. Especially, the last two situations may cause a faulty operation of the facility in question, and may therefore cause loss of information or money, incurred undue costs, malfanction of the facility, and possibly dangerous accidents. However, also deletion may cause nuisance. Feedback to the user can be presented by displaying the recognized phrase. The inventors have realized that the speech recognition is associated with various confidence levels, in that the recognition may be considered correct, questionable, or faulty, and that the overall user interaction would benefit from presenting an indication of the various levels representing such confidence, in association with executing the command or otherwise. Such feedback would indicate to a user person a particular speech item that should be repeated, possibly while being spoken with improved pronunciation or loudness, or rather, that the whole command needs improvement.

### SUMMARY TO THE INVENTION

In consequence, amongst other things, it is an object of the present invention to improve the user interface of such an interactive user facility through representing various such confidence levels with respect to the recognizing of at least selected commands.

Now therefore, according to one of its aspects the invention is characterized according to the characterizing part of claim 1.

The invention also relates to a device arranged for implementing a method as claimed in claim 1. Further advantageous aspects of the invention are recited in dependent Claims.

### BRIEF DESCRIPTION OF THE DRAWING

These and further aspects and advantages of the invention will be discussed more in detail hereinafter with reference to the disclosure of preferred embodiments, and in particular with reference to the appended Figures that show:

FIG. 1, a general speech-enhanced user facility;

FIG. 2, a flow chart illustrating a method embodiment of the present invention.

### DETAILED DESCRIPTION OF PREFERRED EMBODIMENTS

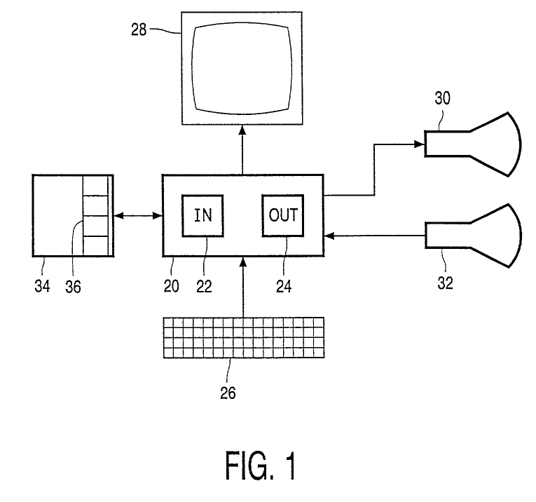

FIG. 1 illustrates a general speech-enhanced user facility for practicing the present invention. Block 20 represents the prime data processing module, such as a personal computer. Block 26 is a device for mechanical user input, such as keyboard, mouse, joystick or the like. Also shown are general block 22 for inputting data, such as memory or network, and general block 24 for outputting data, such as memory, network or printer. Block 34 represents an optional external facility that should be user-controlled, and which interfaces to the computer by I/O devices 36, such as sensors and actuators. The facility may be a consumer audio-video product, a factory automation facility, a motor vehicle information system or another data processing product. The latter external facility need not be present, inasmuch as user control by speech may be effected on the computer itself. Alternatively, the computer itself can form part of the external facility, for example an audio/video apparatus. Finally, there is a bidirectional audio interface with speech input 32 and speech or audio output 30. As will become evident, audio/speech output is optional.

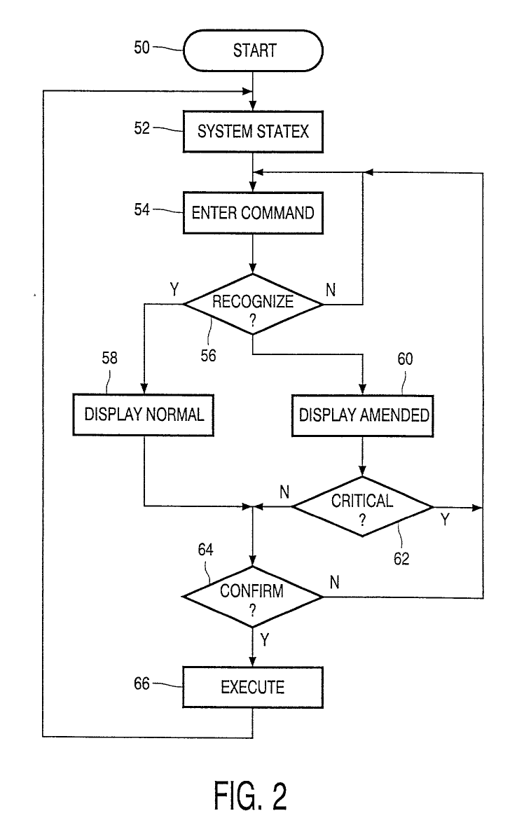

FIG. 2 represents a flow chart illustrating a method embodiment of the present invention. In start block 50 the data processing is activated, together with the assigning of the necessary facilities such as memory. In block 52 the system goes to a state indicated as “STATE X” that represents any applicable situation wherein the recognition of a user speech utterance is relevant for the operation. The attaining of this state so far is irrelevant for the present invention. Also, various further non-relevant aspects of the Figure have been suppressed, such as the eventual leaving of the flow chart. Now, in block 54 the user will enter a speech command, which the system then undertakes to recognize, which recognizing can have an associated level of confidence. In block 56 the actual confidence level of the recognizing is assessed.

Now first, the recognition may be effectively correct, which will lead to displaying the recognized command in a normal manner, block 58. The system then asks the user to confirm, block 64. For this purpose, the system may allow a particular time span of a few seconds, so that non-confirming and not timely confirming will have the same effect. If validly confirmed, the command is executed, block 66, and the system reverts to block 52, that now represents the next system state “STATE X+1” wherein the recognition of a user speech utterance is relevant for the operation. If for a particular command no confirming is deemed necessary, the system would proceed immediately to block 66. For simplicity, the situation wherein no such speech input would be required in the applicable state has been ignored.

Second, the recognition may be faulty. This may be caused by various effects or circumstances. The speech itself may deficient, such as through being soft or inarticulate or occurring in a noisy environment. Also, the content of the speech may be deficient, such as through lacking a particular parameter value. Another problem is caused by superfluous speech elements (ahum!), wrong or inappropriate words or any other sort of lexical or semantic deficiencies. In these cases, the system goes back to block 54. This return may be associated by displaying what has been recognized if anything of the command in question, by a particular audio noise on item 30 in FIG. 1 that indicates such return, by a particular expression in speech such as by displaying a request “repeat command”, or by a textual display of the same. In certain situations, no return is executed, for example, through executing a default action.

Third, the recognition may have a questionable confidence level, which has been indicated by ?. This will cause an amended display of the recognized command in question with respect to the display effected in the case of correct recognition, block 60. The amending may pertain to the whole command, or only to the particular word or words of a plural-word command that effectively have a low confidence level. The amendment may be effected by another font or font size, a bold display versus normal, blinking, color, or any of various attention-grabbing mechanisms that by themselves have been common in text display. A particular feature would be the showing of an associated icon, such as an unsmiling face. Alternatively or in combination therewith, the system may produce an audio feedback that differs from the audio feedback in the case of reliable recognition in block 56, and also differs from the audio feedback in the case of faulty recognition in block 56. In block 62 the system detects existence of a critical situation. This may pertain to an actual or expected command that by itself is critical, or in that the questionable recognition itself would bring about a critical situation. Executing a critical command could ensue high costs such as for example, by transferring money, or by starting a welding operation that cannot be terminated halfway. Deleting of information may or may not be critical, as the case be. If critical however, the system reverts to block 54 for a new speech command entry. If non-critical, the system asks for confirm in block 64, and the situation corresponds to correct recognition. In certain situations, the questionable recognition would need just signaling thereof to a user person, as an urge to improve the quality of the voice commands, such as by better pronunciation.

The procedure may be amended in various manners. The confidence may have more than three levels, each with their associated display amending, categorizing of which is critical and which is not, partial or full repeating of an uttered command, and the like. Persons skilled in the art will appreciate various amendments to the preferred embodiment disclosed supra that would bring about the advantages of the invention, without departing from its scope as defined by the appended Claims hereinafter.

1. A method for operating an interactive user facility through inputting voiced user commands, recognizing such commands, executing such recognized commands, and generating user feedback as regarding the progress of such operating,
said method being characterized by in such recognizing asserting an associated confidence level and generating such user feedback through for a questionable command recognition presenting audio and/or video amending of such feedback both with respect to a correct recognition and with respect to a faulty recognition.

2. A method as claimed in claim 1, wherein such presenting is based on selective amending of a textual display of a recognized command with respect to a standard display.

3. A method as claimed in claim 1, wherein such presenting is based on selective amending of an audio feedback item with respect to a standard audio feedback.

4. A method as claimed in claim 1, wherein such presenting is based on selective iconizing with respect to a standard display.

5. A method as claimed in claim 1, wherein a questionable recognition stalls execution of at least certain of such recognized commands.

6. An apparatus being arranged for practicing a method as claimed in claim 1 for operating an interactive user facility and having input means for receiving voiced user commands, recognizing means for recognizing such commands, execution means for executing such recognized commands, and feedback generating means for generating user feedback as regarding the progress of such operating,
said apparatus being characterized by having asserting means for in such recognizing asserting an associated confidence level and feeding said feedback generating means for generating such user feedback for a questionable command recognition through presenting audio and/or video amending of such feedback both with respect to a correct recognition and with respect to a faulty recognition.

7. An apparatus as claimed in claim 6, and having amending means for selectively amending a textual display of a recognized command with respect to a standard display.

8. An apparatus as claimed in claim 6, and having amending means for selectively amending an audio feedback item with respect to a standard audio feedback.

9. An apparatus as claimed in claim 6, and having amending means for selective iconizing with respect to a standard display.

10. An apparatus as claimed in claim 6, and having stall means activated by a questionable recognition for stalling execution of at least certain of such recognized commands.
